(19) United States
(12) Patent Application Publication
(10) Pub. No.: US 2024/0037986 A1
(43) Pub. Date: Feb. 1, 2024

(54) COMPUTER-READABLE RECORDING MEDIUM STORING TRAINING PROGRAM AND IDENTIFICATION PROGRAM, AND TRAINING METHOD

(71) Applicant: Fujitsu Limited, Kawasaki-shi (JP)

(72) Inventors: Ryosuke KAWAMURA, Kawasaki (JP); Kentaro MURASE, Yokohama (JP)

(73) Assignee: Fujitsu Limited, Kawasaki-shi (JP)

(21) Appl. No.: 18/308,179

(22) Filed: Apr. 27, 2023

(30) Foreign Application Priority Data
Jul. 27, 2022 (JP) 2022-119862

(51) Int. Cl. G06V 40/16; G06V 10/774; G06V 10/26

(52) U.S. Cl. CPC G06V 40/176; G06V 40/172; G06V 40/168; G06V 10/774; G06V 10/26

(57) ABSTRACT

A recording medium stores a program for causing a computer to execute processing including: acquiring images; classifying the images, based on a combination of whether an action unit related to a motion of a portion occurs and whether occlusion is included in an image in which the action unit occurs; calculating a feature amount of the image by inputting each classified image into a model; and training the model so as to decrease a first distance between feature amounts of an image in which the action unit occurs and an image with an occlusion with respect to the image in which the action unit occurs and to increase a second distance between feature amounts of the image with the occlusion with respect to the image in which the action unit occurs and an image with an occlusion with respect to an image in which the action unit does not occur.

### CROSS-REFERENCE TO RELATED APPLICATION

This application is based upon and claims the benefit of priority of the prior Japanese Patent Application No. 2022-119862, filed on Jul. 27, 2022, the entire contents of which are incorporated herein by reference.

### FIELD

The embodiments discussed herein are related to a training program, an identification program, a training method, and an identification method.

### BACKGROUND

With recent development of image processing technology, a system has been developed that detects a subtle change of a human psychological state from an expression (surprise, delight, sorrow, or the like) and executes processing according to the change of the psychological state. As one of representative methods for describing a change in an expression used for this expression detection is description of an expression (expression includes combination of plurality of AUs) using action units (AUs).

JAA-Net: Joint Facial Action Unit Detection and Face Alignment via Adaptive Attention is disclosed as related art.

### SUMMARY

According to an aspect of the embodiments, a non-transitory computer-readable recording medium stores a training program for causing a computer to execute processing including: acquiring a plurality of images that includes a face of a person; classifying the plurality of images, based on a combination of whether or not an action unit related to a motion of a specific portion of the face occurs and whether or not an occlusion is included in an image in which the action unit occurs; calculating a feature amount of the image by inputting each of the plurality of classified images into a machine learning model; and training the machine learning model so as to decrease a first distance between feature amounts of an image in which the action unit occurs and an image with an occlusion with respect to the image in which the action unit occurs and to increase a second distance between feature amounts of the image with the occlusion with respect to the image in which the action unit occurs and an image with an occlusion with respect to an image in which the action unit does not occur.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining an example of a face image;

FIG. 2 is an explanatory diagram for explaining feature amount calculation;

FIG. 3 is an explanatory diagram for explaining training of the feature amount calculation;

FIG. 4 is an explanatory diagram for explaining identification training from a feature amount;

FIG. 5 is a block diagram illustrating a functional configuration example of an information processing device according to a first embodiment;

FIG. 6 is a flowchart illustrating an action example of the information processing device according to the first embodiment;

FIG. 7 is a block diagram illustrating a functional configuration example of an information processing device according to a second embodiment;

FIG. 8 is a flowchart illustrating an action example of the information processing device according to the second embodiment;

FIG. 9 is an explanatory diagram for explaining an example of a computer configuration; and

FIG. 10 is a diagram illustrating an example of an expression recognition rule.

### DESCRIPTION OF EMBODIMENTS

The AU is an action unit of a motion of a face obtained by decomposing an expression based on a face portion and facial muscles and quantifying the expression, and several tens of types such as an AU 1 (pulling up inner side of eyebrows), an AU 4 (lowering eyebrows), or AU 12 (pulling up both ends of lips) are defined in correspondence with the motion of the facial muscles. At the time of expression detection, Occurrence of these AUs (whether or not AU occurs) is identified from a face image to be detected, and a subtle change of the expression is recognized based on the occurred AU.

As the related art for identifying whether or not each AU occurs from a face image, a technique is known for identifying whether or not each AU occurs based on an output obtained by inputting data of the face image into a recognition model by machine learning.

However, the related art described above has a problem in that accuracy for identifying whether or not each AU occurs is deteriorated if a part of a face image is shielded by hair, a mask, or the like (hereinafter, may be referred to as “occlusion”). For example, in a case where a portion where an AU occurs is partially shielded in the face image, it is difficult to recognize whether or not the portion is moved. As an example, in a case where a part of the glabellar is hidden by hair, it is difficult to recognize a motion of the glabellar such as an AU 4 (lowering eyebrows).

In one aspect, an object is to provide a training program, an identification program, a training method, and an identification method that can improve AU identification accuracy.

Hereinafter, a training program, an identification program, a training method, and an identification method according to an embodiment will be described with reference to the drawings. Configurations having the same functions in the embodiments are denoted by the same reference numerals, and redundant description will be omitted. Note that the training program, the identification program, the training method, and the identification method described in the following embodiments are merely examples, and do not limit the embodiments. Furthermore, each of the following embodiments may be appropriately combined unless otherwise contradicted.

[Expression Recognition System]

Next, an overall configuration of an expression recognition system according to the present embodiment will be described. The expression recognition system includes a plurality of cameras and an information processing device that analyzes video data. Furthermore, the information processing device recognizes an expression of a person, using an expression recognition model, from a face image of the person imaged by the camera. The expression recognition model is an example of a machine learning model that generates expression information regarding an expression that is an example of a feature amount of a person. For example, the expression recognition model is a machine learning model that estimates an action unit (AU) that is a method for decomposing an expression based on parts and facial muscles of a face and quantifying the expression. This expression recognition model outputs an expression recognition result such as “AU 1: 2, AU 2: 5, AU 4: 1, . . . ” in which each of AUs from the AU 1 to the AU 28 set to specify an expression is expressed as an occurrence intensity (for example, five steps evaluation), according to an input of image data.

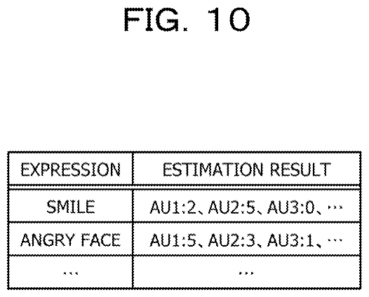

The expression recognition rule is a rule used to recognize an expression using an output result of the expression recognition model. FIG. 10 is a diagram illustrating an example of the expression recognition rule. As illustrated in FIG. 10, the expression recognition rule stores an “expression” and an “estimation result” in association with each other. The “expression” is an expression to be recognized, and the “estimation result” is an intensity of each of the AU 1 to the AU 28 corresponding to each expression. The example in FIG. 10 illustrates that an expression is recognized as “smile” in a case where “the AU 1 has an intensity 2, the AU 2 has an intensity 5, the AU 3 has an intensity 0, . . . ”. Note that the expression recognition rule is data that has been registered in advance by an administrator or the like.

### Outline of Embodiment

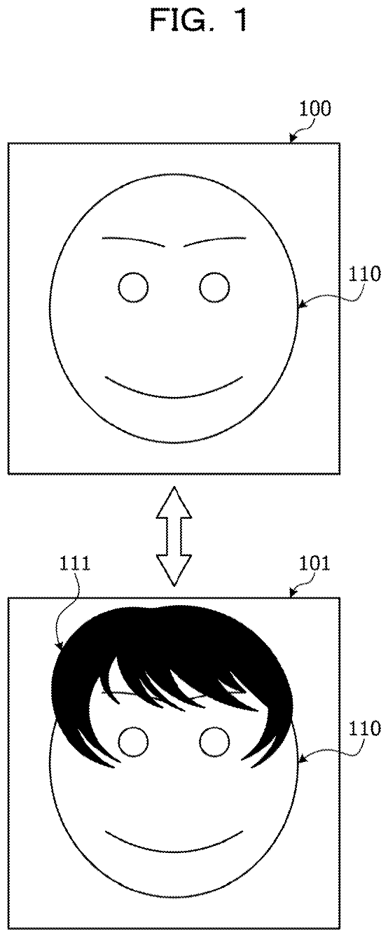

FIG. 1 is an explanatory diagram for explaining an example of a face image. As illustrated in FIG. 1, face images 100 and 101 are images including a face 110 of a person. In a case where the face is not hidden (no occlusion) like the face 110 in the face image 100, whether or not wrinkles between eyebrows (AU 04) occur can be correctly identified.

On the other hand, in a case where a part of the glabellar is hidden by hair 111 of the face 110 (with occlusion) as in the face image 101, it is difficult to see wrinkles of the skin in the glabellar portion due to the occlusion, and for example, an edge of the hair 111 may be erroneously recognized as a wrinkle. Therefore, with a recognition model according to the related art, in a case where there is an occlusion in the glabellar portion, it is difficult to correctly identify whether or not the wrinkles between the eyebrows (AU 04) occur.

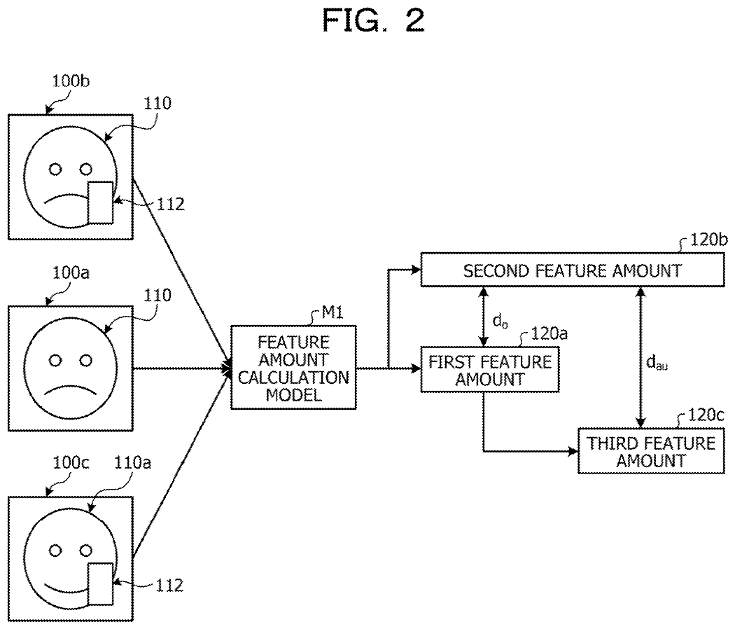

FIG. 2 is an explanatory diagram for explaining feature amount calculation. As illustrated in FIG. 2, an information processing device according to an embodiment inputs each of face images 100a, 100b, and 100c that are classified into some patterns into a feature amount calculation model M1 and calculates feature amounts (first feature amount 120a, second feature amount 120b, and third feature amount 120c) regarding each image. Note that, in the following description, it is assumed that the feature amount be referred to as a feature amount 120 in a case where the feature amounts regarding the respective images are not particularly distinguished.

Here, the feature amount calculation model M1 is a machine learning model that calculates the feature amount 120 regarding an image for the input image and outputs the feature amount 120. To this feature amount calculation model M1, a neural network such as generative multi-column convolutional neural networks (GMCNN) or generative adversarial networks (GAN) can be applied. An image input to this feature amount calculation model M1 may be a still image or an image sequence in chronological order. Furthermore, the feature amount 120 calculated by the feature amount calculation model M1 may be any information as long as information indicates a feature of an input image, such as vector information indicating a motion of facial muscles of a face included in an image or the like or an Intensity (occurrence intensity) of each AU.

The face image 100a is an image in which an action unit (AU) of pulling up both ends of the lips (AU 15) occurs in the face 110 (no occlusion). A feature amount calculated by inputting this face image 100a into the feature amount calculation model M1 is the first feature amount 120a. Note that whether or not both ends of the lips are pulled up (AU 15) is described in the embodiment. However, the AU is not limited to the AU 15 and may be any AU.

The face image 100b is an image in which an occlusion occurs due to a shielding object 112 at the mouth in the face 110 where the AU (AU 15) for pulling up both ends of the lips occurs. A feature amount calculated by inputting this face image 100b into the feature amount calculation model M1 is the second feature amount 120b.

The face image 100c is an image in which an occlusion occurs due to the shielding object 112 at the mouth in the face 110 where the AU (AU 15) for pulling up both ends of the lips does not occur. A feature amount calculated by inputting this face image 100c into the feature amount calculation model M1 is the third feature amount 120c. Note that, in the following description, it is assumed that the face images 100a, 100b, and 100c be referred to as a face image 100 in a case where the face images 100a, 100b, and 100c are not particularly distinguished from each other.

The information processing device according to the embodiment obtains a first distance (dₒ) between the first feature amount 120a of the face image 100a in which the AU occurs (no occlusion) and the second feature amount 120b of the face image 100b with an occlusion with respect to the face image 100a in which the AU occurs. Next, the information processing device according to the embodiment trains the feature amount calculation model M1 so as to decrease the first distance (dₒ).

Furthermore, the information processing device according to the embodiment obtains a second distance (dₐᵤ) between the second feature amount 120b of the face image 100b with an occlusion with respect to the face image 100a in which the AU occurs and the third feature amount 120c of the face image 100c with an occlusion with respect to an image in which no AU occurs. Next, the information processing device according to the embodiment trains the feature amount calculation model M1 so as to increase the second distance (dₐᵤ).

For example, the information processing device acquires the feature amount from the neural network by inputting the face image 100 into the neural network. Then, the information processing device generates a machine learning model in which a parameter of the neural network is changed, so as to reduce an error with correct answer data, in the acquired feature amount. The feature amount calculation model M1 is trained so as to decrease the first distance (dₒ) and increase the second distance (dₐᵤ).

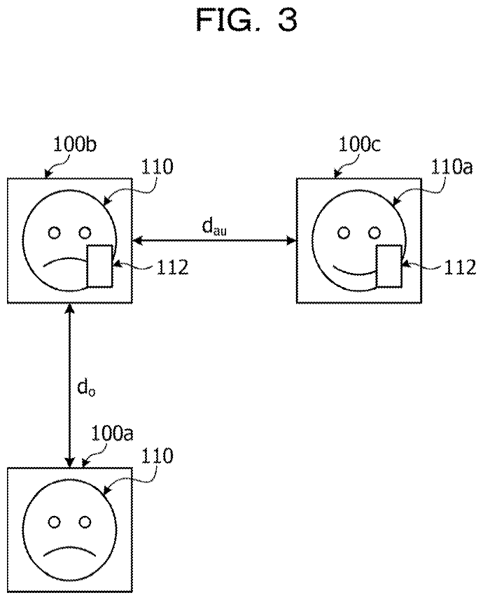

FIG. 3 is an explanatory diagram for explaining training of the feature amount calculation. As illustrated in FIG. 3, the information processing device according to the embodiment can reduce an effect of the occlusion due to the shielding object 112 on the feature amount output by the feature amount calculation model M1 by training the feature amount calculation model M1 so as to decrease the first distance (dₒ) and increase the second distance (dₐᵤ).

For example, in a case where the face images 100a and 100b in which the AU occurs are input into the feature amount calculation model M1 after training, a difference caused according to whether or not the occlusion occurs hardly occurs in the feature amount. Furthermore, in a case where the face images 100b and 100c, in which the occlusion occurs and whether or not the AU occurs is different, is input to the feature amount calculation model M1 after training, a difference caused according to whether or not the AU occurs easily occurs in the feature amount.

Note that the information processing device according to the embodiment trains the feature amount calculation model M1 so as to decrease the first distance (dₒ) and increase the second distance (dₐᵤ), based on a loss function (Loss) of the following formula (1). Here, mₒ and mₐᵤ are margin parameters respectively related to the first distance (dₒ) and the second distance (dₐᵤ). This margin parameter adjusts a margin of a distance at the time of calculating the loss function (Loss) and is assumed as, for example, a set value arbitrarily set by a user.

[Expression 1]

Loss=max(0,dₒ+mₒ−dₐᵤ+mₐᵤ) (1)

With the loss function (Loss) in the formula (1), in a case where a difference between the feature amounts is caused according to whether or not the occlusion occurs even if the first distance (dₒ) is large and the AU occurs, a loss increases. Furthermore, with the loss function (Loss) in the formula (1), in a case where the second distance (dₐᵤ) is small, whether or not the AU occurs is different from each other, and the difference between the feature amounts does not occur due to the occlusion, the loss increases.

Furthermore, the information processing device according to the embodiment trains an identification model that identifies whether or not the AU occurs, based on a feature amount obtained by inputting an image to which correct answer information indicating whether or not an AU occurs is added into the feature amount calculation model M1 described above. This identification model may be a machine learning model by a neural network different from the feature amount calculation model M1 or may be an identification layer arranged at a subsequent state of the feature amount calculation model M1.

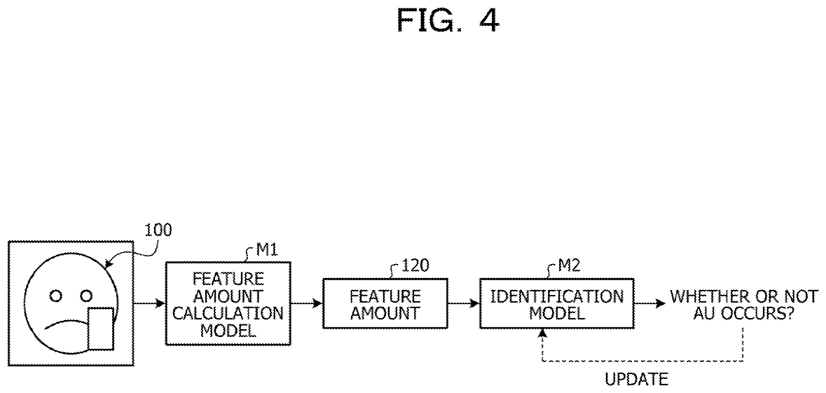

FIG. 4 is an explanatory diagram for explaining identification training from a feature amount. As illustrated in FIG. 4, the information processing device according to the embodiment obtains the feature amount 120 by inputting the face image 100 to which the correct answer information indicating whether or not the AU occurs is added, into the feature amount calculation model M1 after training. Here, the correct answer information is a sequence (AU 1, AU 2, . . . ) indicating whether or not each AU occurs or the like. For example, in a case where a sequence (1, 0, . . . ) is added to the face image 100 as the correct answer information, it is indicated that the AU 1 occurs in the face image 100.

In a case of inputting the feature amount 120 into an identification model M2, the information processing device according to the embodiment trains the identification model M2 by updating a parameter of the identification model M2 so that the identification model M2 outputs a value corresponding to whether or not the AU occurs indicated by the correct answer information. The information processing device according to the embodiment can identify whether or not the AU occurs in the face, from a face image to be identified, by using the feature amount calculation model M1 and the identification model M2 that have trained in this way.

For example, the information processing device acquires a feature amount indicating whether or not the AU occurs, from the neural network, by inputting the feature amount 120 into the neural network. Then, the information processing device generates a machine learning model in which a parameter of the neural network is changed, so as to reduce an error with correct answer data, in the acquired feature amount.

### First Embodiment

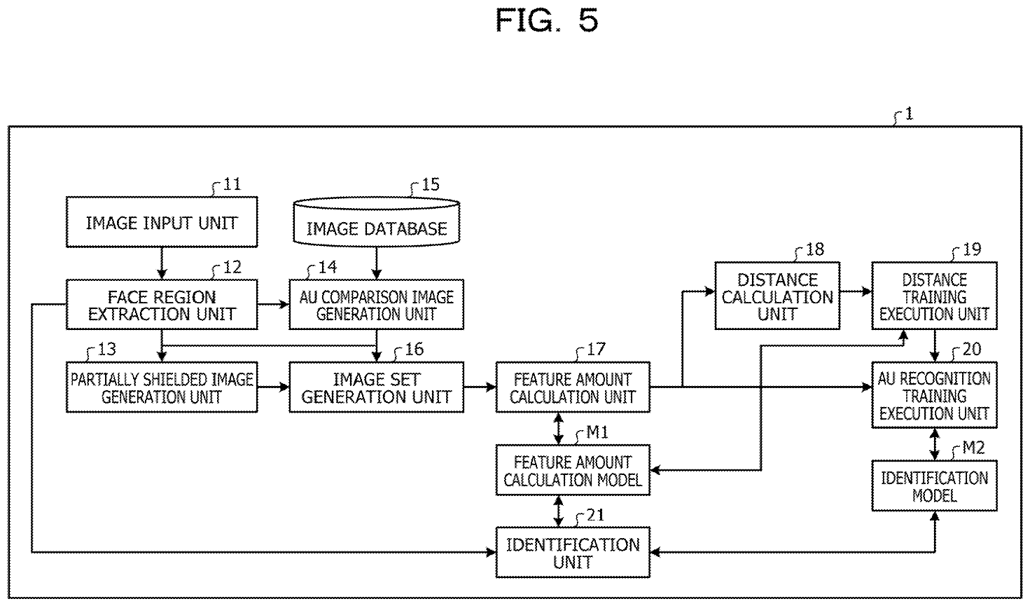

FIG. 5 is a block diagram illustrating a functional configuration example of an information processing device according to a first embodiment. As illustrated in FIG. 5, an information processing device 1 includes an image input unit 11, a face region extraction unit 12, a partially shielded image generation unit 13, an AU comparison image generation unit 14, an image database 15, an image set generation unit 16, a feature amount calculation unit 17, a distance calculation unit 18, a distance training execution unit 19, an AU recognition training execution unit 20, and an identification unit 21.

The image input unit 11 is a processing unit that receives an input of an image from outside via a communication line or the like. For example, the image input unit 11 receives an input of an image to be a training source and correct answer information indicating whether or not an AU occurs at the time of training a feature amount calculation model M1 and an identification model M2. Furthermore, the image input unit 11 receives an input of an image to be identified at the time of identification.

The face region extraction unit 12 is a processing unit that extracts a face region included in the image received by the image input unit 11. The face region extraction unit 12 specifies a face region from the image received by the image input unit 11, through known face recognition processing, and assumes the specified face region as a face image 100. Next, the face region extraction unit 12 outputs the face image 100 to the partially shielded image generation unit 13, the AU comparison image generation unit 14, and the image set generation unit 16 at the time of training the feature amount calculation model M1 and the identification model M2. Furthermore, the face region extraction unit 12 outputs the face image 100 to the identification unit 21 at the time of identification.

The partially shielded image generation unit 13 is a processing unit that generates an image (face images 100b and 100c) with an occlusion in which the face image 100 (with no occlusion) output from the face region extraction unit 12 and the AU comparison image generation unit 14 is partially shielded. For example, the partially shielded image generation unit 13 generates an image obtained by masking the face image 100 with no occlusion by partially hiding at least an action portion where the AU occurs indicated as the correct answer information. Next, the partially shielded image generation unit 13 outputs the generated image (image with occlusion) to the image set generation unit 16.

For example, in a case where pulling up both ends of the lips (AU 15) is indicated as the correct answer information, the partially shielded image generation unit 13 generates a masked image in which an action portion corresponding to the AU 15 that is a portion around the mouth is partially hidden. The same applies to action portions corresponding to other AUs. For example, in a case where pulling up the inner side of the eyebrow (AU 1) is indicated as the correct answer information, the partially shielded image generation unit 13 generates a masked image in which a part of the eyebrow that is an action portion corresponding to the AU 1 is hidden.

Note that masking is not limited to masking a part of the action portion and may be masking a portion other than the action portion. For example, the partially shielded image generation unit 13 may mask a partial region randomly designated with respect to an entire region of the face image 100.

The AU comparison image generation unit 14 is a processing unit that generates an image of which whether or not the AU occurs is opposite to that indicated by the correct answer information, for the face image 100 output from the face region extraction unit 12. For example, the AU comparison image generation unit 14 refers to the image database 15 that stores a plurality of face images of a person to which whether or not the AU occurs is added and acquires the image of which whether or not the AU occurs is opposite to that indicated by the correct answer information. The AU comparison image generation unit 14 outputs the acquired image to the partially shielded image generation unit 13 and the image set generation unit 16.

Here, the image database 15 is a database that stores a plurality of face images. To each face image stored in the image database 15, information indicating whether or not each AU occurs (for example, sequence (AU 1, AU 2, . . . ) indicating whether or not each AU occurs) is added.

The AU comparison image generation unit 14 refers to this image database 15, and for example, in a case where the sequence (1, 0, . . . ) indicating that the AU 1 occurs is the correct answer information, the AU comparison image generation unit 14 acquires a corresponding face image indicating that the AU 1 does not occur (0,* (optional), . . . ). As a result, the AU comparison image generation unit 14 obtains the image of which whether or not the AU occurs is opposite to that of the input face image 100 to be a training source.

For example, the image input unit 11, the face region extraction unit 12, the partially shielded image generation unit 13, and the AU comparison image generation unit 14 are examples of an acquisition unit that acquires a plurality of images including a face of a person.

The image set generation unit 16 is a processing unit that generates an image set that is obtained by classifying face images (face images 100a, 100b, and 100c) output from the face region extraction unit 12, the partially shielded image generation unit 13, and the AU comparison image generation unit 14 into any one of patterns of combinations of whether or not the AU occurs and whether or not an occlusion included in the image with the AU. For example, the image set generation unit 16 is an example of a classification unit that classifies each of the plurality of images.

For example, the image set generation unit 16 classifies images into an image set (face images 100a, 100b, and 100c) used to obtain a first distance (dₒ) and a second distance (dₐᵤ).

As an example, the image set generation unit 16 combines three types of images including the face image 100a output from the face region extraction unit 12 for the input image to which the correct answer information with the AU is added, the face image 100b output from the partially shielded image generation unit 13 after masking the face image 100a, and the face image 100c that is generated by the AU comparison image generation unit 14 as an image of which whether or not the AU occurs is opposite to that of the face image 100a and is output after masking by the partially shielded image generation unit 13.

Note that the image set generation unit 16 may classify the images into an image set (face images 100a and 100b) used to obtain the first distance (dₒ) and an image set (face images 100b and 100c) used to obtain the second distance (dₐᵤ).

The feature amount calculation unit 17 is a processing unit that calculates a feature amount 120 for each image of the image set generated by the image set generation unit 16. For example, the feature amount calculation unit 17 obtains an output (feature amount 120) from the feature amount calculation model M1, by inputting each image of the image set into the feature amount calculation model M1.

The distance calculation unit 18 is a processing unit that calculates the first distance (dₒ) and the second distance (dₐᵤ), based on the feature amount 120 regarding each image of the image set calculated by the feature amount calculation unit 17. For example, the distance calculation unit 18 calculates the first distance (dₒ), based on a feature amount according to the image set obtained by combining the face images 100a and 100b. Similarly, the distance calculation unit 18 calculates the second distance (dₐᵤ), based on a feature amount according to the image set obtained by combining the face images 100b and 100c.

The distance training execution unit 19 is a processing unit that trains the feature amount calculation model M1 so as to decrease the first distance (dₒ) and increase the second distance (dₐᵤ), based on the first distance (dₒ) and the second distance (dₐᵤ) calculated by the distance calculation unit 18. For example, the distance training execution unit 19 adjusts a parameter of the feature amount calculation model M1 using a known method such as backpropagation, so as to reduce a loss in a loss function of the formula (1) described above.

The distance training execution unit 19 stores a parameter related to the feature amount calculation model M1 after training or the like in a storage device (not illustrated). Therefore, the identification unit 21 can obtain the feature amount calculation model M1 after training by the distance training execution unit 19 by referring to the information stored in the storage device at the time of identification.

The AU recognition training execution unit 20 is a processing unit that trains the identification model M2, based on the correct answer information indicating whether or not the AU occurs and the feature amount 120 calculated by the feature amount calculation unit 17. For example, in a case of inputting the feature amount 120 into the identification model M2, the AU recognition training execution unit 20 updates the parameter of the identification model M2 so that the identification model M2 outputs a value corresponding to whether or not the AU occurs indicated by the correct answer information.

The AU recognition training execution unit 20 stores a parameter related to the identification model M2 after training in a storage device or the like (not illustrated). Therefore, the identification unit 21 can obtain the identification model M2 after training by the AU recognition training execution unit 20, by referring to information stored in the storage device, at the time of identification.

The identification unit 21 is a processing unit that identifies whether or not the AU occurs, based on the face image 100 extracted from the image to be identified by the face region extraction unit 12.

For example, the identification unit 21 constructs the feature amount calculation model M1 and the identification model M2, by obtaining the parameters regarding the feature amount calculation model M1 and the identification model M2 by referring to the information stored in the storage device. Next, the identification unit 21 obtains the feature amount 120 regarding the face image 100, by inputting the face image 100 extracted by the face region extraction unit 12 into the feature amount calculation model M1. Next, the identification unit 21 obtains information indicating whether or not the AU occurs, by inputting the obtained feature amount 120 into the identification model M2. The identification unit 21 outputs an identification result obtained in this way (whether or not AU occurs) to, for example, a display device, or the like.

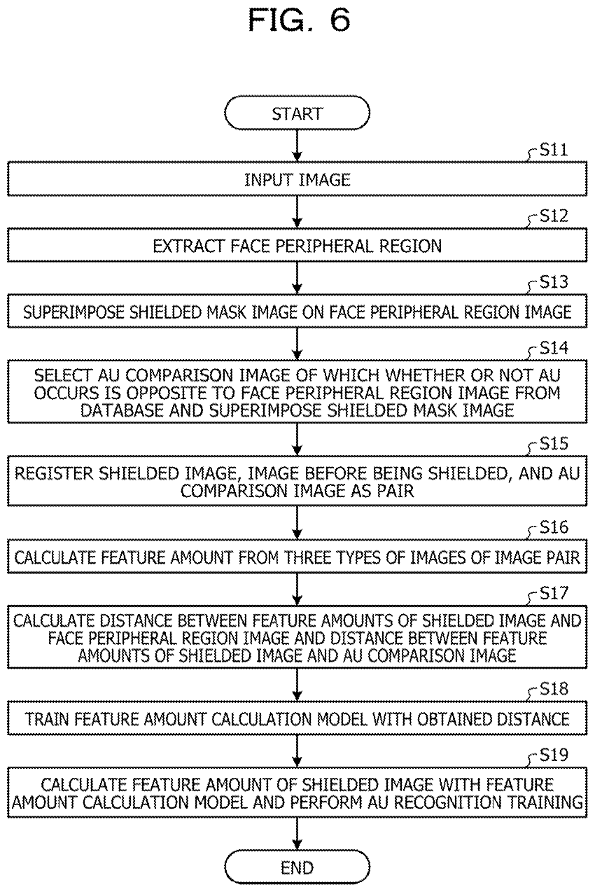

FIG. 6 is a flowchart illustrating an action example of the information processing device 1 according to the first embodiment. As illustrated in FIG. 6, when processing starts, the image input unit 11 receives an input of an image to be a training source (including correct answer information) (S11).

Next, the face region extraction unit 12 extracts a face peripheral region by executing face recognition processing on the input image (S12). Next, the partially shielded image generation unit 13 superimposes a shielded mask image on a face peripheral region image (face image 100) (S13). As a result, the partially shielded image generation unit 13 generates a shielded image with an occlusion with respect to the face image 100 (no occlusion).

Next, the AU comparison image generation unit 14 selects an AU comparison image of which whether or not the AU occurs is opposite to that of the face peripheral region image (face image 100) from the image database 15 and acquires the AU comparison image. Next, the partially shielded image generation unit 13 superimposes the shielded mask image on the acquired AU comparison image (S14). As a result, the partially shielded image generation unit 13 generates an image with an occlusion with respect to the AU comparison image (with no occlusion).

Next, the image set generation unit 16 registers the shielded image, the image before being shielded (face peripheral region image (face image 100)), and the AU comparison image (with occlusion) as a pair (S15). Next, the feature amount calculation unit 17 calculates the feature amounts 120 (first feature amount 120a, second feature amount 120b, and third feature amount 120c) respectively from three types of images of the image pair (S16).

Next, the distance calculation unit 18 calculates a distance (dₒ) between the feature amounts of the shielded image and the face peripheral region image and a distance (dₐᵤ) between the feature amounts of the shielded image and the AU comparison image (with occlusion) (S17).

Next, the distance training execution unit 19 trains the feature amount calculation model M1 so as to decrease the first distance (dₒ) and increase the second distance (dₐᵤ), based on the distances (dₒ and dₐᵤ) obtained by the distance calculation unit 18 (S18).

Next, the AU recognition training execution unit 20 calculates the feature amount 120 of the shielded image by the feature amount calculation model M1. Next, the AU recognition training execution unit 20 performs AU recognition training so that the identification model M2 outputs the value corresponding to whether or not the AU occurs indicated by the correct answer information in a case where the calculated feature amount 120 is input into the identification model M2 (S19) and ends the processing.

### Second Embodiment

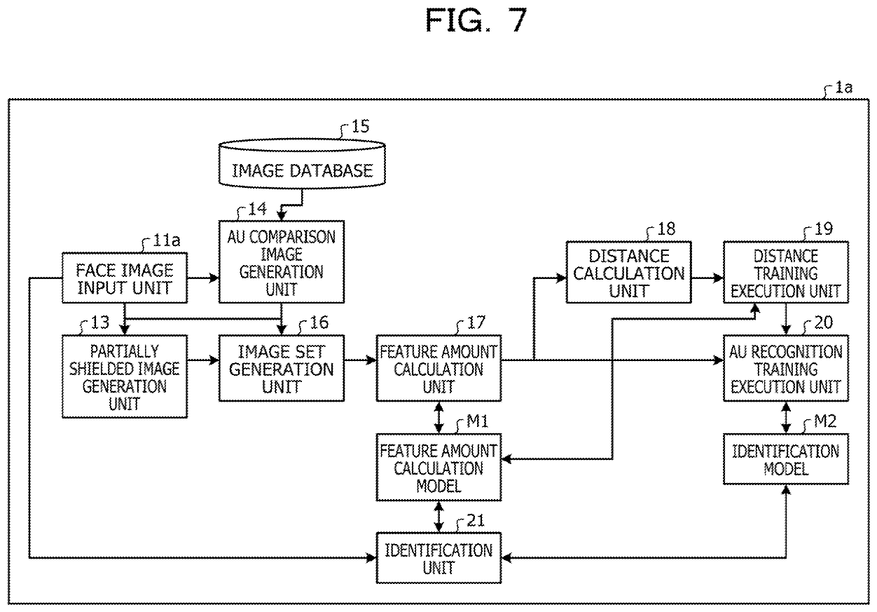

FIG. 7 is a block diagram illustrating a functional configuration example of an information processing device according to a second embodiment. As illustrated in FIG. 7, an information processing device 1a according to the second embodiment has a configuration including a face image input unit 11a that receives an input of image data of which a face image has been extracted in advance. For example, the information processing device is according to the second embodiment is different from the information processing device 1 according to the first embodiment in that the face region extraction unit 12 is not included.

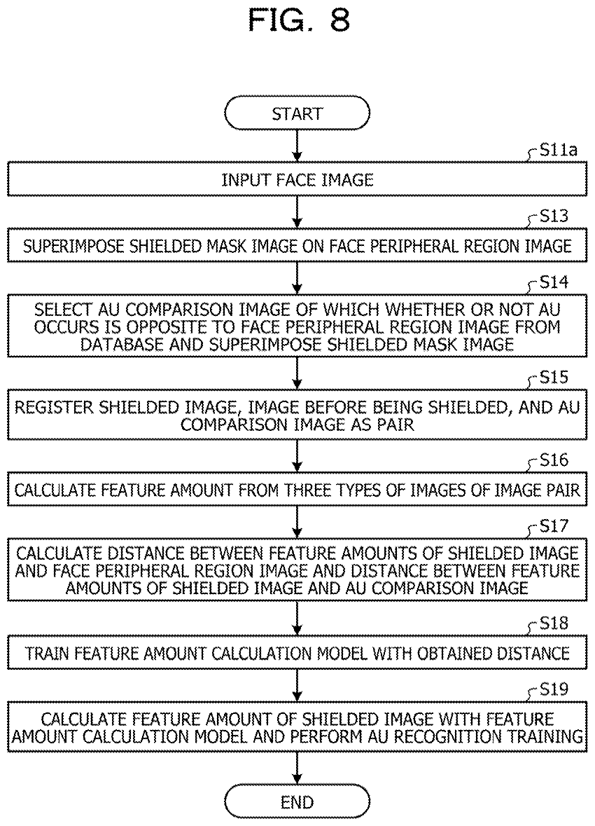

FIG. 8 is a flowchart illustrating an action example of the information processing device 1a according to the second embodiment. As illustrated in FIG. 8, the information processing device 1a does not need to extract a face peripheral region (S12) because the face image input unit 11a receives the input of the face image (S11a).

### Effects

As described above, the information processing devices 1 and 1a acquire the plurality of images including the face of the person. The information processing devices 1 and 1a classify each of the plurality of images into any pattern obtained by combining whether or not a specific action unit (AU) related to a motion of a face occurs and whether or not an occlusion is included in the image in which the action unit occurs. The information processing devices 1 and 1a calculate the feature amount of the image by inputting each of the images classified into the patterns into the feature amount calculation model M1. The image input units 11 and 11a trains the feature amount calculation model M1 so as to decrease the first distance between the feature amounts of the image in which the action unit occurs and the image with the occlusion with respect to the image in which the action unit occurs and to increase the second distance between the feature amounts of the image with the occlusion with respect to the image in which the action unit occurs and the image with the occlusion with respect to the image in which the action unit does not occur.

In this way, the information processing devices 1 and 1a can train the feature amount calculation model M1 so as to reduce the effect of the occlusion and output a magnitude of a change of the face image due to the occurrence of the specific action unit (AU) as a feature amount. Therefore, by identifying the AU using the feature amount obtained by inputting the image to be identified into the feature amount calculation model M1 after training, it is possible to accurately identify whether or not the AU occurs even if the image to be identified includes an occlusion.

Furthermore, the information processing devices 1 and 1a refer to the image database 15 that stores the plurality of face images of the person to which whether or not the action unit occurs is added, based on the input image with the correct answer information indicating whether or not the action unit occurs and acquires the image of which whether or not the action unit occurs is opposite to whether or not the action unit occurs in the input image. As a result, the information processing devices 1 and 1a can obtain both of the image in which the action unit occurs and the image in which the action unit does not occur, from the input image.

Furthermore, the information processing devices 1 and 1a shield a part of the image and acquire an image with an occlusion, based on the image acquired by referring to the input image and the image database 15. As a result, the information processing devices 1 and 1a can obtain the image with occlusion of the images in which the action unit occurs/does not occur, from the input image.

Furthermore, when acquiring the image with the occlusion, the information processing devices 1 and 1a shield at least a part of the action portion related to the action unit. As a result, the information processing devices 1 and 1a can obtain the image with occlusion in which at least a part of the action portion related to the action unit is shielded. Therefore, since the information processing devices 1 and 1a can proceed training of the feature amount calculation model M1 using the image with the occlusion in which at least a part of the action portion related to the action unit is shielded, the information processing devices 1 and 1a can efficiently train a case where the action portion is shielded.

Furthermore, the information processing devices 1 and 1a train the feature amount calculation model M1 based on the loss function Loss of the formula (1) when the first distance is set to dₒ, the second distance is set to dₐᵤ, the margin parameter regarding the first distance is set to mₒ, and the margin parameter regarding the second distance is set to mₐᵤ. As a result, the information processing devices 1 and 1a can train the feature amount calculation model M1 so as to decrease the first distance and increase the second distance, with the loss function Loss.

Furthermore, the information processing devices 1 and 1a train the identification model M2 so as to output whether or not the action unit occurs indicated by the correct answer information, in a case where the feature amount obtained by inputting the image to which the correct answer information indicating whether or not the action unit occurs is added into the feature amount calculation model M1 is input. As a result, the information processing devices 1 and 1a can train the identification model M2 for identifying whether or not the action unit occurs, based on the feature amount obtained by inputting the image into the feature amount calculation model M1.

Furthermore, the information processing devices 1 and 1a acquire the trained feature amount calculation model M1 and identify whether or not the specific action unit occurs in the face of the person included in the image to be identified, based on the feature amount obtained by inputting the image to be identified including the face of the person into the acquired feature amount calculation model M1. As a result, even in a case where the image to be identified includes the occlusion, the information processing devices 1 and 1a can accurately identify whether or not the specific action unit occurs based on the feature amount obtained by the feature amount calculation model M1.

(Others)

Note that each of the illustrated components in each of the devices does not necessarily have to be physically configured as illustrated in the drawings. For example, specific modes of distribution and integration of the respective devices are not limited to those illustrated, and all or a part of the respective devices may be configured by being functionally or physically distributed and integrated in an optional unit depending on various loads, use situations, or the like.

Furthermore, all or some of various processing functions of the information processing devices 1 and 1a (image input unit 11, face image input unit 11a, face region extraction unit 12, partially shielded image generation unit 13, AU comparison image generation unit 14, image set generation unit 16, feature amount calculation unit 17, distance calculation unit 18, distance training execution unit 19, AU recognition training execution unit 20, and identification unit 21) may be executed on a central processing unit (CPU) (or microcomputer such as a microprocessor (MPU) or a micro controller unit (MCU)). Furthermore, it is needless to say that all or some of various processing functions may be executed on a program analyzed and executed by a CPU (or microcomputer such as an MPU or an MCU) or on hardware by wired logic. Furthermore, various processing functions performed by the information processing device 1 may be executed by a plurality of computers in cooperation through cloud computing.

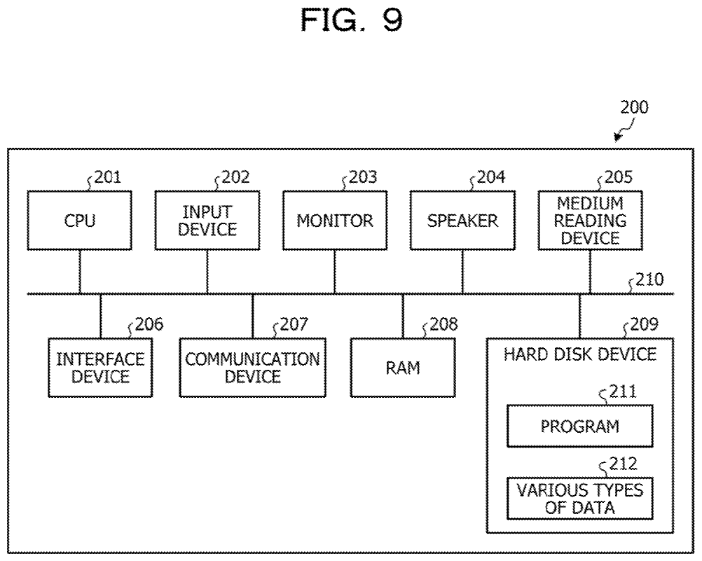

Meanwhile, various processing functions described in the embodiments described above may be implemented by executing a program prepared beforehand on a computer. Thus, hereinafter, an example of a computer configuration (hardware) that executes a program having functions similar to the functions of the embodiments described above will be described. FIG. 9 is an explanatory diagram for explaining an example of a computer configuration.

As illustrated in FIG. 9, a computer 200 includes a CPU 201 that executes various types of arithmetic processing, an input device 202 that receives data input, a monitor 203, and a speaker 204. Furthermore, the computer 200 includes a medium reading device 205 that reads a program or the like from a storage medium, an interface device 206 to be coupled to various devices, and a communication device 207 to be coupled to and communicate with an external device in a wired or wireless manner. Furthermore, the information processing device 1 includes a random-access memory (RAM) 208 that temporarily stores various types of information, and a hard disk device 209. Furthermore, each of the units (201 to 209) in the computer 200 is coupled to a bus 210.

The hard disk device 209 stores a program 211 used to execute various types of processing of various processing functions described above (for example, image input unit 11, face image input unit 11a, face region extraction unit 12, partially shielded image generation unit 13, AU comparison image generation unit 14, image set generation unit 16, feature amount calculation unit 17, distance calculation unit 18, distance training execution unit 19, AU recognition training execution unit 20, and identification unit 21). Furthermore, the hard disk device 209 stores various types of data 212 that the program 211 refers to. The input device 202 receives, for example, an input of operation information from an operator. The monitor 203 displays, for example, various screens operated by the operator. The interface device 206 is coupled to, for example, a printing device or the like. The communication device 207 is coupled to a communication network such as a local area network (LAN), and exchanges various types of information with an external device via the communication network.

The CPU 201 performs various types of processing regarding various processing functions described above by reading the program 211 stored in the hard disk device 209 and loading the program 211 into the RAM 208 to execute the program 211. Note that the program 211 does not have to be stored in the hard disk device 209. For example, the program 211 stored in a storage medium readable by the computer 200 may be read and executed. For example, the storage medium readable by the computer 200 corresponds to a portable recording medium such as a compact disc read-only memory (CD-ROM), a digital versatile disc (DVD), or a universal serial bus (USB) memory, a semiconductor memory such as a flash memory, a hard disk drive, or the like. Furthermore, this program 211 may be prestored in a device coupled to a public line, the Internet, a LAN, or the like, and the computer 200 may read the program 211 from this device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a training program for causing a computer to execute processing comprising:
acquiring a plurality of images that includes a face of a person;
classifying the plurality of images, based on a combination of whether or not an action unit related to a motion of a specific portion of the face occurs and whether or not an occlusion is included in an image in which the action unit occurs;
calculating a feature amount of the image by inputting each of the plurality of classified images into a machine learning model; and
training the machine learning model so as to decrease a first distance between feature amounts of an image in which the action unit occurs and an image with an occlusion with respect to the image in which the action unit occurs and to increase a second distance between feature amounts of the image with the occlusion with respect to the image in which the action unit occurs and an image with an occlusion with respect to an image in which the action unit does not occur.

2. The non-transitory computer-readable recording medium according to claim 1, wherein
the acquiring processing refers to a storage unit that stores a plurality of face images of a person to which whether or not the action unit occurs is added, based on an input image with correct answer information that indicates whether or not the action unit occurs and acquires an image of which whether or not the action unit occurs is opposite to whether or not the action unit occurs in the input image.

3. The non-transitory computer-readable recording medium according to claim 2, wherein
the acquiring processing acquires an image with an occlusion by shielding a part of the image, based on the input image and the acquired image.

4. The non-transitory computer-readable recording medium according to claim 3, wherein
the acquiring processing shields at least a part of an action portion related to the action unit.

5. The non-transitory computer-readable recording medium according to claim 1, wherein
the training processing trains the machine learning model based on a loss function Loss of a formula (1):
Loss=max(0,dₒ+mₒ−dₐᵤ+mₐᵤ) (1)
when the first distance is set to dₒ, the second distance is set to dₐᵤ, a margin parameter regarding the first distance is set to mₒ, and a margin parameter regarding the second distance is set to mₐᵤ.

6. The non-transitory computer-readable recording medium according to claim 1, for causing a computer to further execute processing comprising:
training an identification model so as to output whether or not an action unit occurs indicated by correct answer information, in a case where a feature amount obtained by inputting an image to which the correct answer information that indicates whether or not the action unit occurs is added into the machine learning model is input.

7. A non-transitory computer-readable recording medium storing an identification program for causing a computer to execute processing comprising:
calculating a feature amount of an image by inputting each of a plurality of images classified based on a combination of whether or not an action unit related to a motion of a specific portion of a face of a person occurs and whether or not an occlusion is included in an image in which the action unit occurs into a machine learning model and acquiring the machine learning model that is trained to decrease a distance between feature amounts of an image in which the action unit occurs and an image with an occlusion with respect to the image in which the action unit occurs and to increase a distance between feature amounts of an image with an occlusion with respect to the image in which the action unit occurs and an image with an occlusion with respect to an image in which the action unit does not occur; and
identifying whether or not a specific action unit occurs in a face of a person included in an image to be identified, based on a feature amount obtained by inputting the image to be identified that includes the face of the person into the acquired machine learning model.

8. A training method comprising:
acquiring a plurality of images that includes a face of a person;
classifying the plurality of images, based on a combination of whether or not an action unit related to a motion of a specific portion of the face occurs and whether or not an occlusion is included in an image in which the action unit occurs;
calculating a feature amount of the image by inputting each of the plurality of classified images into a machine learning model; and
training the machine learning model so as to decrease a first distance between feature amounts of an image in which the action unit occurs and an image with an occlusion with respect to the image in which the action unit occurs and to increase a second distance between feature amounts of the image with the occlusion with respect to the image in which the action unit occurs and an image with an occlusion with respect to an image in which the action unit does not occur.

9. The training method according to claim 8, wherein
the acquiring processing refers to a storage unit that stores a plurality of face images of a person to which whether or not the action unit occurs is added, based on an input image with correct answer information that indicates whether or not the action unit occurs and acquires an image of which whether or not the action unit occurs is opposite to whether or not the action unit occurs in the input image.

10. The training method according to claim 9, wherein
the acquiring processing acquires an image with an occlusion by shielding a part of the image, based on the input image and the acquired image.

11. The training method according to claim 10, wherein
the acquiring processing shields at least a part of an action portion related to the action unit.

12. The training method according to claim 8, wherein
the training processing trains the machine learning model based on a loss function Loss of a formula (1):
Loss=max(0,dₒ+mₒ−dₐᵤ+mₐᵤ) (1)
when the first distance is set to dₒ, the second distance is set to dₐᵤ, a margin parameter regarding the first distance is set to mₒ, and a margin parameter regarding the second distance is set to mₐᵤ.

13. The training method according to claim 8, for causing a computer to further execute processing comprising:
training an identification model so as to output whether or not an action unit occurs indicated by correct answer information, in a case where a feature amount obtained by inputting an image to which the correct answer information that indicates whether or not the action unit occurs is added into the machine learning model is input.
